(19) United States
(12) Patent Application Publication
(10) Pub. No.: US 2012/0158705 A1
(43) Pub. Date: Jun. 21, 2012

(54) LOCAL SEARCH USING FEATURE BACKOFF

(75) Inventors: Arnd Christian Konig, Kirkalnd, WA (US); Klaus L. Berberich, Saarbrucken (DE); Dimitrios Lymberopoulos, Bellevue, WA (US)

(73) Assignee: MICROSOFT CORPORATION, Redmond, WA (US)

(21) Appl. No.: 12/970,928

(22) Filed: Dec. 16, 2010

(51) Int. Cl. G06F 17/30

(52) U.S. Cl. 707/723; 707/E17.014

(57) ABSTRACT

A local search system is described herein that provides a framework for the integration of various external sources to improve local search ranking. The framework provided by the local search system described herein uses a notion of backoff. The system uses a generalization of the concept of backoff to improve local search results that incorporate a variety of data features. The system can apply backoff in multiple dimensions at the same time to generate features for local search ranking. The system integrates various additional data sources, such as web access logs, driving direction request logs, reviews, and so forth, to quantify popularity and distance (or distance sensitivity) into a framework for local search ranking. Thus, the system provides search results that are more relevant by incorporating a number of data sources into the ranking in a manner that handles abnormalities in the data well.

### BACKGROUND

Search has become a popular way for users to interact with computer systems. Users today search the Internet via search engines that crawl the World Wide Web periodically to identify websites and the content within them. Users search their hard drives and other storage for files based on filenames, contents, and so forth. Users search email through email programs and other types of content through other programs. Search engines typically build an index that is used to look up content based on one or more input keywords or phrases. Search is typically designed to give similar results for any instance of a query, though the results may improve over time due to better indexing, better interpretation of query terms, and so forth. For example, two users searching the Internet for “how to make pizza” will receive similar results from most search engines listing recipe sites and the like.

One specialized area of search is local search. A local search query is any query that has location or geographic proximity as a relevance driver for search results. As opposed to general search, local search seeks to give each user different results based on location, either where the user is located or in a geographic area of concern for the user. An example is a query for “pizza delivery”. Unlike the general query for how to make a pizza above, a user searching a search engine for pizza delivery is likely interested in local pizza businesses that deliver to the user's location. The relevance of the search results to the user will take into account, in part, how close a particular business represented by a result is to the user. Mapping and other local search services (e.g., MICROSOFT™ BING™ Maps and MICROSOFT™ BING™ Local) are targeted to performing relevant local searches.

The ranking of results in local search often involves the combination of three factors: the relevance of a search result (e.g., does the query match the name or type of the business), the popularity of a search result (e.g., number of web pages that mention the business), and the distance between the searcher and a geographic entity associated with the result (e.g., distance from user location to business). To assess these factors, it is often useful to integrate external data sources such as click-logs for non-local web search (to obtain a popularity signal), logs on driving directions (to obtain a signal on sensitivity to increasing distance), and so forth. This integration is difficult and can produce spotty results where there is little available data or where the data for one factor is much more readily available than that for another.

### SUMMARY

A local search system is described herein that provides a framework for the integration of various external sources to improve local search ranking. In some embodiments, the system identifies candidate businesses in a pre-filtering step. Then, the system ranks candidate businesses using machine-learning techniques, and handles different levels of granularity/sparseness in the external sources being integrated. Sparseness refers to the lack of information about some businesses for some factors. While there may be a lot of data to leverage for common entities, there are likely to be few mentions of rare ones in logs or other data sources. Hence, the system uses a coarser level of aggregation when leveraging this information. Another common data problem is handling outliers or errors. The framework provided by the local search system described herein uses a notion of backoff originally proposed in the context of language models to integrate entities with varying numbers of observations into a consistent model. The system uses a generalization of the concept of backoff to improve local search results that incorporate a variety of data features. The system can apply backoff in multiple dimensions at the same time to generate features for local search ranking. The system integrates various additional data sources, such as web access logs, driving direction request logs, reviews, and so forth, to quantify popularity and distance (or distance sensitivity) into a framework for local search ranking. Thus, the system provides search results that are more relevant by incorporating a number of data sources into the ranking in a manner that handles abnormalities in the data well.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the local search system, in one embodiment.

FIG. 2 is a flow diagram that illustrates processing of the local search system to perform a search of local entities using supplemental location-specific information, in one embodiment.

FIG. 3 is a flow diagram that illustrates processing of the local search system to smooth potentially unreliable supplemental information with backoff, in one embodiment.

FIG. 4 is a set of graphs that illustrates interactions of multiple supplemental information dimensions using the local search system, in one embodiment.

### DETAILED DESCRIPTION

A local search system is described herein that provides a framework for the integration of various external sources to improve local search ranking. In some embodiments, the system identifies candidate businesses in a pre-filtering step. Then, the system ranks candidate businesses using machine-learning techniques (e.g., multiple additive regressions trees (MART)). The system handles different levels of granularity/sparseness in the external sources being integrated. Sparseness refers to the lack of information about some businesses for some factors. For example, a new pizza delivery business may have no reviews, but the system may be designed to rank results, in part, by how good the reviews for each business are. While there may be a lot of data to leverage for common entities, there are likely to be few mentions of rare ones in logs or other data sources. Hence, the system uses a coarser level of aggregation when leveraging this information. Another common data problem is handling outliers or errors. For example, when considering distance past users have traveled to visit a business (e.g., based on driving direction requests), most users may drive from across town while one user drove from across the country as part of a trip. The cross-country trip result is an outlier and not indicative of how far typical users will drive to visit the business. In some embodiments, the system does not classify such cases as outliers or errors, but rather allows the training process to handle this automatically. For example, because these are rare cases, the MART model (or any other model used) will assign a very low probability.

The framework provided by the local search system described herein uses a notion of backoff originally proposed in the context of language models to integrate entities with varying numbers of observations into a consistent model. The system uses a generalization of the concept of backoff to improve local search results that incorporate a variety of data features. The system can apply backoff in multiple dimensions at the same time to generate features for local search ranking. For example, the system may handle sparse review data in combination with distance information that contains outliers. The system integrates various additional data sources, such as web access logs, driving direction request logs, reviews, and so forth, to quantify popularity and distance (or distance sensitivity) into a framework for local search ranking. In some embodiments, the system can pre-compute some combinations of backoff dimensions to improve performance during queries. The system may select the previously determined most relevant combinations for pre-computation as a manner of making the most popular queries fast. Thus, the system provides search results that are more relevant by incorporating a number of data sources into the ranking in a manner that handles abnormalities in the data well.

Because there is typically little original information about each business (even more so the smaller the business and category in which the user is searching), the ability to integrate other information assets, such as VIRTUAL EARTH™ logs, browser click logs, direction requests, and so forth, provides a number of interesting data points that can be used by the local search system to rank search results. For example, the system can determine information such as an average route time of direction requests to the business location, an average route length, a percentage of clicks on a business website, a percentage of clicks from the searcher's zip code or other geographic boundary on a site or business, and so on. As the granularity at which data is viewed increases, the amount of data available decreases. For example, when looking at the zip code level or at a single business, there is much less available information than at a broader level. There may be only a few or no observations. As a result, incorporating this information naively into search ranking leads to values that are neither very reliable not stable.

Various types of backoff and smoothing can be applied to the external data to generate values that are more reliable and stable. For example, Katz backoff has been used in language modeling where there are too few observations in a dataset, while Jelinek-Mercer smoothing has been used in information retrieval (IR) language models to estimate the probability of generating a word from a particular document. Click-through rate (CTR) prediction in sponsored search often factors in click-through rates of similar queries or queries from similar categories to infer data that is not directly available. These and other techniques can be applied to external data sources for local search to produce stable and reliable features for result ranking in search.

As an example, while responding to a user search request for “Fresh Way Pizza” assume the system wants to determine the click popularity of Fresh Way Pizza's uniform resource locator (URL) among users in the searcher's zip code. If the system finds that there are few or no clicks, popularity is difficult or impossible to directly determine. However, the system may identify similar data, such as the popularity of Pizza Hut's URL in the searcher's zip code as a hint to the popularity of the pizza category in that area in general. The system may also have data for Fresh Way Pizza's URL from a neighboring zip code and can use this information to fill out the data available about Fresh Way Pizza to provide reliable ranking. Backoff can occur in multiple dimensions, including in this example business categories, business location, and searcher location.

Mathematically, this can be expressed as follows. Given as input a universe of objects O (corresponding to observations in the external logs), a source object oₛ (corresponding to the combination of a user location and a specific result business), and distance dimensions D, then aggregated distance of an object o from oₛ is defined as:

d(oₛ,o):=Σ_{d}_{ᵢ}_{εD}dᵢ(oₛ,o)

For the distance dimensions permitted for backoff (D_{B}⊂D) the following holds: ∀dᵢεD\D_{B}:dᵢ(oₛ, o)=0 (i.e., all other dimensions must remain fixed). This produces an output set of objects: B(oₛ, D_{B}) ⊂0, which are then used to generate features.

The system considers distance dimensions such as categorical distance between businesses (e.g., defined as 1.0−Jaccard(Cat(B₁),Cat(B₂))), geographic distance between businesses, geographic distance between searchers, and U.S. zip-code distance between businesses (e.g., defined as 5−|CommonPrefix(Z₁,Z₂)|). The system may normalize determined distances to deal with different scales and distributions according to the following equation:

$${d}_{i}^{N} ( {o}_{s} , {o}_{t} ) = \frac{\vert \{ o ∈ o \vert {d}_{i} ( {o}_{s} , o ) < {d}_{i} ( {o}_{s} , {o}_{t} ) \} \vert}{\vert o \vert}$$

In some embodiments, the local search system performs a pivot backoff that applies a distance threshold a backoff to the maximal number of objects that lie in a bounding box defined by a pivot object oₚ as follows:

argmaxₒ_{ₚ}|{oεO|d(oₛ,o)≦α [symbol] ∀i:dᵢ(oₛ,o)≦dᵢ(oₛ,oₚ)}|

s.t.d(oₛ,oₚ)≦α

B(oₛ,D_{B})={oεO|∀i:dᵢ(oₛ,o)≦dᵢ(oₛ,oₚ)}

Because objects in B(oₛ, D_{B}) are guaranteed not to exceed the distance of the pivot object in any individual dimension, choosing them based on a pivot ensures their coherence.

In some embodiments, the local search system backs off in parallel using difference values of α combined with different choices of D_{B} and relies on feature selection by/for the machine-learning based ranker (e.g., MART) to select the right combinations. For a backoff method (e.g., PIVOT), a choice of D_{B}, a value of α (e.g., 0.01), and a feature (e.g., click popularity) the system generates backoff features representing the count, mean, and standard deviation. Only backoff features picked up by MART need to be computed efficiently at query processing time.

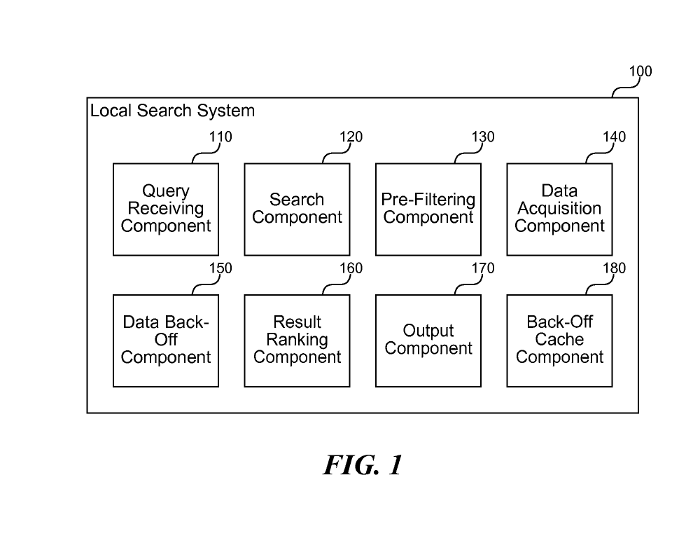

FIG. 1 is a block diagram that illustrates components of the local search system, in one embodiment. The system 100 includes a query receiving 110, a search component 120, a pre-filtering component 130, a data acquisition component 140, a data backoff component 150, a result ranking component 160, an output component 170, and a backoff cache component. Each of these components is described in further detail herein.

The query receiving component 110 receives a query from a user that requests a search for local businesses. The query may include one or more keywords, category selections, or other input data that specifies the user's request. The query receiving component 110 may provide a user interface, such as a web page search box or desktop application control. The system 100 may also be a component of larger systems and the query receiving component 110 may provide a programmatic application programming interface (API) through which other components invoke the system 100 to request query results. Upon receiving a query, the query receiving component 110 invokes the search component to begin the search, which culminates in the system 100 providing one or more ranked search results via the output component 170 in response to the request.

The search component 120 performs a search based on the query using a pre-built search index that classifies a set of content. The content may include Internet web pages, files, locations, documents, audiovisual content, and so forth. The search component 120 may include a general search engine that provides non-local search results, which the system then ranks to move local search results to the top. The search component provides output to the pre-filtering component 130 to eliminate irrelevant or less relevant data from the initial result set.

The pre-filtering component 130 eliminates results based on the search that are not related to one or more current local criteria. For example, the component 130 may apply a category filter or other information to reduce the size of the result set to a set of results for which the system will apply additional externally acquired data for ranking the results. The pre-filtering step can be as minimal or as aggressive as there is information available that can help eliminate unwanted results from the data set before applying more complex and performance-sensitive processes to rank the result set.

The data acquisition component 140 acquires supplemental information for ranking multiple identified search results from one or more external data sources. External data sources can include click logs, driving direction logs, time information, location information, distance information, user demographic information, and any other data that can help produce a more relevant and well-ranked set of search results. The data acquisition component 140 may operate on a periodic basis independent of arrival of search requests to gather and process supplemental information before queries arrive to reduce the impact on query processing performance. Alternatively or additionally, the component 140 may seek out relevant data at the time of a query based on information provided by or inferred from the query. For large datasets, pre-acquiring data that is useful and relevant to unknown queries may be impractical. In some embodiments, the data acquisition component 140 pre-acquires data for popular categories or other subsets and dynamically acquires data for less popular subsets. This allows the system 100 to provide a high performance user experience for common cases.

The data backoff component 150 applies one or more backoff criteria to acquired supplemental information to manage errors or sparseness in the acquired data. For example, the acquired data may include little information related to a user's current location but substantial information about a neighboring location. The system can leverage the neighboring location information to make informed guesses and provide relevance ranking for results related to the user's location. The same is possible with category information, driving distance, weather, time, and so on. The data backoff component 150 can apply backoff in multiple dimensions to smooth unrelated or related types of data gathered from difference sources. For example, the system may smooth both driving distance and category distance (i.e., match level) at the same time. Multiple dimension backoff can use a variety of methods, including near-neighbor and pivot models. Near-neighbor backoff produces a sloped result that heightens the effect of one dimension of backoff when another dimension has a lower value. For example, if two dimensions are geographic distance and category match, the system may accept results with greater geographic distances when the category match is closer and vice versa. Pivot backoff decouples each dimension so that a constant cutoff is used in each dimension. For example, results may be eliminated outside of a threshold category match level and outside of a separate threshold geographic distance.

The result ranking component 160 ranks search results according to the applied backoff criteria and acquired supplemental information. If the supplemental information were flawless, meaning it was equally robust for each search entity, there would be no need for backoff. The system 100 would simply incorporate the effect of the supplemental information in ranking the search results yielding results that are more relevant at the top. However, because the supplemental information has a number of flaws, including sparseness, anomalies, and outright errors, the backoff produces a robust dataset that appears to the ranking component 160 to be complete and error free. The data backoff component 150 provides close neighboring data for use to rank dimensions when the available supplemental information for that dimension is sparse or non-existent. If the supplemental information contains errors or anomalies, the data backoff component 150 provides smoothing that reduces the effect of outlying data. This allows the result ranking component 160 to rank search results according to a common formula that incorporates multiple location-related dimensions without erratic and unreliable results when the supplemental information does not provide a definitive signal.

The output component 170 provides output that includes the ranked search results. The output may include a user interface, such as a web page with search results, or a programmatic API that provides a data structure for applications that leverage the system 100 to obtain local search results. The output component 170 may provide output data in a variety of formats, such as Hypertext Markup Language (HTML), extensible markup language (XML), proprietary data formats, and so forth.

The backoff cache component 180 caches processed results from the data acquisition component 140 and the data backoff component 150 to save time during subsequent search queries. The supplemental information gathered by the data acquisition component 140 may change slowly enough that the system 100 can leverage calculations made based on the supplemental information for some amount of time (e.g., a day) before needing to reacquire the data. Likewise, the backoff calculations performed by the data backoff component 150 may remain valid and useful for a period of time during which the backoff cache component 180 can store the processed information and reuse the information for sufficiently time correlated queries. The backoff cache component 180 is an optional component for improving performance that may or may not be present in any particular embodiment of the system 100.

The computing device on which the local search system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

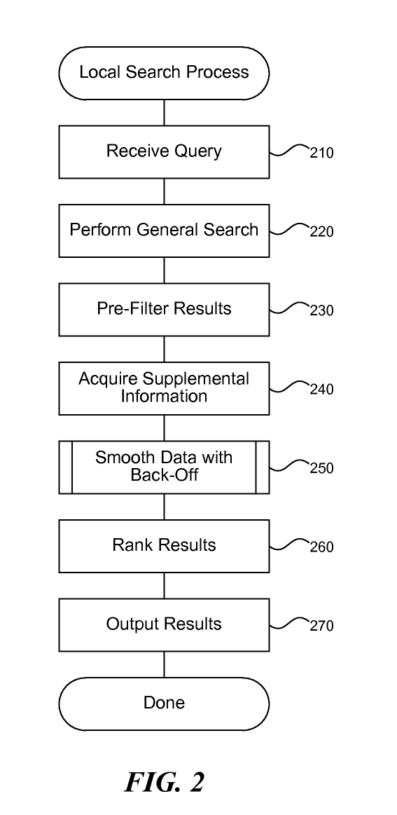

FIG. 2 is a flow diagram that illustrates processing of the local search system to perform a search of local entities using supplemental location-specific information, in one embodiment.

Beginning in block 210, the system receives a search query from a user searching for one or more local entities. The entities may include businesses, landmarks, people, or other geographically locatable objects. The search query may include one or more keywords, categories, location specifications, and other information. For example, a user may perform a search on a device that captures the user's current location (e.g., using a global positioning system (GPS) chip or triangulating software based on other signals) and provides the captured location in the query. The user may also specify a location to perform a query related to a location at which the user plans to be in the future (e.g., on a trip). The system identifies businesses or other entities near the specified location that match other information specified by the query.

Continuing in block 220, the system performs a general search that identifies a body of matching results. The results may include content items that matched based on keywords or based on a coarse specification of location that the system will rank in subsequent steps to bring results that are more relevant to the top of a list of results. The system may submit the keywords provided by the user as well as additional keywords based on the user's location to an existing search engine to produce a first pass at search results to be refined in the following steps.

Continuing in block 230, the system pre-filters the identified results to eliminate irrelevant search results. The system may be able to eliminate some results as clearly not relevant or beyond a threshold of relevance so that the system can reduce the size of the list of results for which the system performs supplemental information processing. The pre-filtering step is optional and, if used, provides a performance benefit to the query processing by reducing the data size for subsequent steps.

Continuing in block 240, the system acquires one or more dimensions of supplemental information related to location that provide one or more hints describing relevance of individual search results. For example, the supplemental information may include user driving direction requests to a location of a local entity associated with each search result, reviews or other rankings of an entity associated with each search result, a closeness of each search result's category with a category (or categories) identified by the search query, and so forth. The system may acquire the supplemental information from a variety of sources, including by accessing files stored in a datacenter or offered remotely by a server.

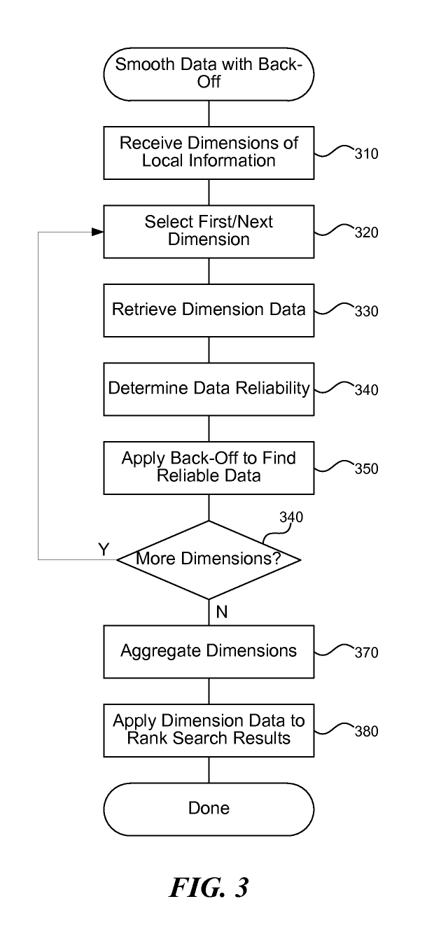

Continuing in block 250, the system smoothes one or more dimensions of the acquired supplemental information to handle data sparseness and anomalies. For example, the system may apply backoff as described herein to loosen particular dimension values (e.g., extending a zip code dimension to consider neighboring zip codes, or a category dimension to consider close categories or parent categories in a hierarchy) where matching data is not otherwise available. In addition, the system may reject outliers or normalize data to reduce the impact of infrequently occurring outlying data values (e.g., directions to a location that exceed a distance threshold). This process is described further with reference to FIG. 3.

Continuing in block 260, the system ranks the search results based on the smoothed dimensions of the acquired supplemental data. The smoothing ensures a rich dataset even where data was initially sparse. The ranking moves results higher in the list that are more likely to be liked by the user. For example, if other users have rated a local entity highly, then that entity will probably be liked by the current user and the system ranks a result associated with the entity higher. As another example, if other users have been willing to drive from the user's approximate location to the location of a particular entity, then the system may conclude that the current user would be willing to drive that distance also and rank such results higher (while eliminating or reducing rank of results outside this distance). In the end, the system attempts to place results near the top of the list that the user would prefer if the user had time to exhaustively review the list. Searches today often produce many thousands of results such that users only access the first 10-20 results, so ranking results is highly relevant to directing the user's attention to useful information. Continuing in block 270, the system outputs the ranked results to the user. The output may include displaying the ranked results on a display or monitor, such as via a web browser or other application running on a computing device of the user. The system may also provide other types of output, such as programmatic output, auditory output, mapping directions on a mobile device, and so forth. After block 270, these steps conclude.

FIG. 3 is a flow diagram that illustrates processing of the local search system to smooth potentially unreliable supplemental information with backoff, in one embodiment. Beginning in block 310, the system receives one or more dimensions of supplemental information for ranking results of a local search query designed to identify one or more local entities related to a search query. Dimensions may include any type of information that distinguishes one result from another. For example, a time dimension may indicate whether other users have found a particular search results relevant at a particular time of day (e.g., to eliminate restaurants that are potentially closed at the time of the search). As another example, a category dimension may indicate how satisfied other users were with categories of entities related to a category identified by a user's search request.

Continuing in block 320, the system selects a first received dimension. The system iterates through each dimension in the following steps and upon subsequent iterations selects the next received dimension in block 320. Continuing in block 330, the system retrieves dimension data related to the selected dimension. For example, if the dimension relates to user reviews of business entities, then the system retrieves user reviews for each entity identified by a current set of search results. The system may find that some entities have many reviews, while other entities have none, referred to as sparseness. As another example, another dimension may relate to distance users are willing to travel to visit an entity based on driving directions requests to a mapping application. The system can match the destination address of the driving directions to the address of each entity and determine the average distance to the starting address. Again, some entities may have no or few directions requests, whereas others may have many.

Continuing in block 340, the system determines a reliability measure of the retrieved dimension data. The reliability measure may measure the data's sparseness, rate of outliers, past reliability history, or other indicators that the data either can be trusted or is of a sufficient quantity from which to infer relevance information. For example, the system may determine that fewer than five user reviews for an entity indicates an unreliable signal in a user reviews dimension. As another example, the system may determine that receiving fewer than 10 directions requests indicates an unreliable signal in a user distance dimension.

Continuing in block 350, the system applies backoff to identify related dimension data that fills any gaps in data for the selected dimension. For example, if the selected dimension is a zip-code and a current value is 98052 (Redmond, Wash.), the system may apply backoff to the value to determine that where insufficient data is available for a reliable signal from 98052, backing-off to incorporate data from a neighboring zip-code 98007 (Bellevue, Wash.) is satisfactory to increase the reliability of the data. The system may also remove or smooth outlying data that exceeds a threshold or determine an average of data to reduce outlier impact on the data.

Continuing in decision block 360, if there are more received dimensions, then the system loops to block 320 to consider the next dimension, else the system continues at block 370. Continuing in block 370, the system aggregates data for each dimension to create a score for each search result. Aggregation refers to applying each dimension to the data to arrive at a combined effect of the dimensions. The dimensions may be weighted so that some dimensions exert more influence on the score than others do. In some embodiments, the system determines a sub-score associated with each dimension, applies any weighting, and adds the weighted subs-core to a total to achieve the score for all of the dimensions. Continuing in block 380, the system applies the aggregated dimension data to rank search results. After block 380, these steps conclude. Although shown serially for ease of illustration, these steps can also be performed in parallel or in various groupings. For example, the pivot backoff described herein considers multiple dimensions at once by selecting a pivot candidate and performing backoff in multiple dimensions at the same time based on the selected candidate.

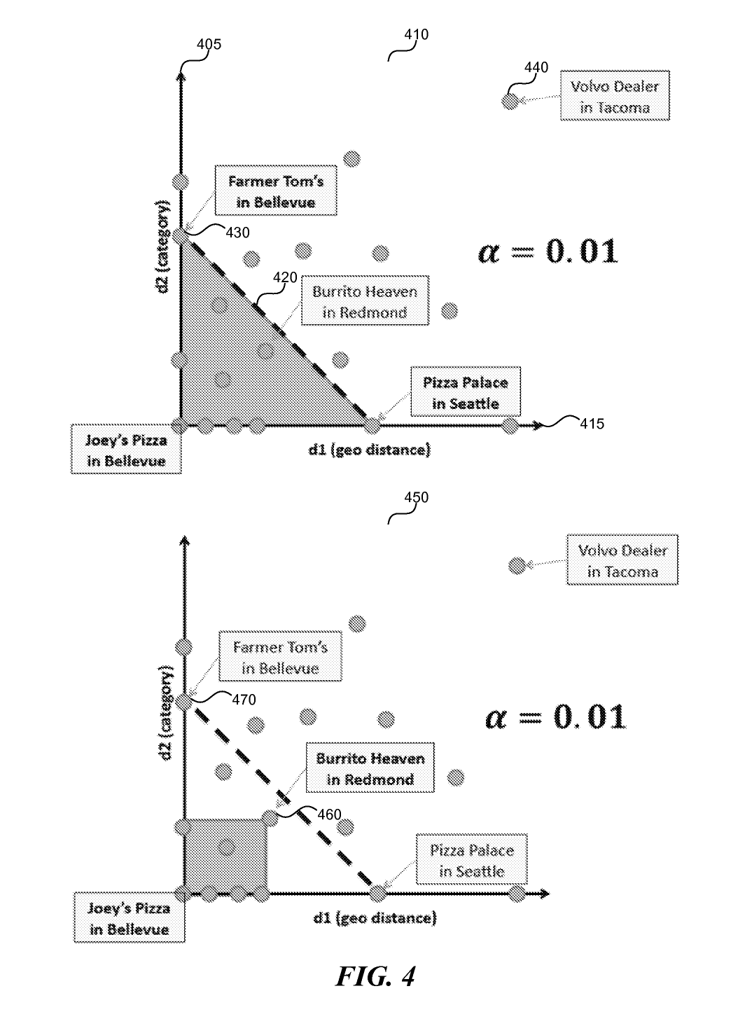

FIG. 4 is a set of graphs that illustrates interactions of multiple supplemental information dimensions using the local search system, in one embodiment. The figure includes a first graph 410 and a second graph 420. The first graph 410 illustrates results of a near-neighbor backoff method. The near-neighbor backoff method includes all entities in the backoff set that have an aggregated distance below a threshold. The graph 410 includes an x-axis 415 that plots geographic distance between a user and each entity and a y-axis that plots how closely a category of each entity matches a search category. The backoff set includes all entities in the shaded triangular region 420. For example, a first entity 430 falls within the backoff set while a second entity 440 does not. The near-neighbor backoff method has the result that as one dimension's effect decreases, another increases. For example, the more closely the category matches (moving down the y-axis 405), the more the geographic distance is allowed to increase (moving right along the x-axis 415). This may be desirable in some implementations of the system and not in others. An implementer can select a backoff method appropriate for the particular application.

The second graph 450 illustrates results of applying a pivot backoff method. Pivot backoff produces a set of results that are both individually close to a source object and are coherent with one another. A pivot object 460 is selected (or a threshold for each axis can be chosen independent of objects) that creates a maximal backoff set size while ensuring that the pivot object and all other objects in the backoff set have aggregated distance below a specified threshold. With this method, the first object 470 that was included in the near-neighbor method is no longer included. Coherence ensures that once a category is partially in the backoff set then all results in that category are in the set (that meet similar other dimension criteria). For example, for a restaurant search for pizza delivery, it may be unusual to include some Italian restaurants (a backoff of the category dimension) because they are geographically close, but not others (because they are too far away even though other results at that or greater distance were included). In some cases, a pivot is faster to determine because intersection is a fast operation compared to finding the area under the triangle in the first graph 410.

In some embodiments, the local search system may select multiple pivots. There may be some entities for which the system has a specific reason for including in the results. Perhaps they relate to sponsored listings or known highly preferred listings selected by users. These objects are good candidates for pivots, but selecting the most distant object may include too many results in the backoff set. By selecting multiple pivots, the system can create a set of stair steps of the boxes in the second graph of FIG. 4. Multiple pivots still ensure a high level of coherence while including reliable results.

In some embodiments, the local search system iterates over potential pivot objects to select one that fits a threshold distance or backoff set size. The system may walk through pivots determining the size of the backoff set if each were selected and the maximal distance created by each, then select a pivot that creates a particular size range or distance. In some embodiments, the system may apply multiple distance functions or backoff steps in parallel and select an appropriate result based on application-specific criteria.

In some embodiments, the local search system performs offline training of a classifier to determine which dimensions are most useful. The system can apply machine-learning techniques to past data to determine which dimensions and thresholds produce good results and to tune the system over time.

### Research Results

The following paragraphs present select data from use of one embodiment of the local search system to generate search results. This information provides further information about implementation of the system but is not intended to limit the system to those embodiments and circumstances discussed. Those of ordinary skill in the art will recognize various modifications and substitutions that can be made to the system to achieve similar or implementation-specific results.

Local search queries—which can be defined as queries that employ user location or geographic proximity (in addition to search keywords, a business category, or a product name) as a key factor in result quality—are becoming a more frequent part of (web) search. Specialized local search verticals are now part of all major web search engines and typically surface businesses, restaurants or points-of-interest relevant to search queries. Moreover, their results are also often integrated with “regular” web search results on the main search page when appropriate. Perhaps most importantly, local searches are one of the most commonly used and useful application on mobile devices.

Because of the importance of location and the different types of results (typically businesses, restaurants and points-of-interest as opposed to web pages) surfaced by local search engines, the signals used in ranking local search results are very different from the ones used in web search ranking. For example, consider the local search query [pizza], which is intended to surface restaurants selling pizza near the user. For this (type of) query, the keyword(s) in the query itself do very little for ranking, beyond eliminating businesses that do not feature pizza (in the text associated with them). Moreover, the businesses returned as local search results are often associated with significantly less text than web pages, giving traditional text-based measures of relevance less content to leverage. Instead, key signals used to rank results for such queries are (i) the geographic distance of the result business from the user's location and (ii) a measure of its popularity (note that additional signals such as the current weather, time, or personalization features can also be integrated into our overall framework).

Both of these signals are difficult to assess directly based on click information derived from the local search vertical itself, in part due to the position bias of the click signal. Our approach therefore leverages external data sources (e.g., logs of driving-direction requests) to quantify these two signals. In case of result popularity, the related notion of preference has been studied in the context of web search; however, techniques to infer preferences in this context are based on randomized swaps of results, which are not desirable in a production system, especially in the context of mobile devices which only display a small number of results at the same time. Other techniques used to quantify the centrality or authority of web pages (e.g., those based on their link structure) do not directly translate to the business listings surfaced by local search.

Instead, we look into data sources from which we can derive popularity measures specific to local search results; for example, one might use customer ratings, the number of accesses to the business website in search logs, or—if available—data on business revenues or the number of customers. Depending on the type of business and query, different sources may yield the most informative signal. Customer ratings, for instance, are common for restaurants but rare for other types of businesses. Other types of businesses (e.g., plumbers) may often not have a web site, so that there is no information about users' access activity.

In case of result distance, it easy to compute the geographic distance between a user and a business once their locations are known. This number itself, however, does not really reflect the willingness of a user to travel to the business in question. For one, the sensitivity to distance is a function of the type of business that is being ranked: for example, users may be willing to drive 20 minutes for a furniture store, but not for a coffee shop. Moreover, if the travel is along roads or subways, certain locations may be much easier to reach for a given user than others, even though they have the same geographic distance; this can even lead to asymmetric notions of distance, where travel from point A to B is much easier than from B to A or simply much more common. Again, it is useful to employ external data sources to assess the correct notion of distance for a specific query: for example, one may use logs of driving-direction requests from map verticals—by computing the distribution of requests ending at specific businesses, one might assess what distances users are willing to travel for different types of businesses. Alternatively, one might use mobile search logs to assess the variation in popularity of a specific business for groups of users located in different zip codes, etc. As before, the different logs may complement each other.

One challenge for integrating these external data sources stem from the fact that they are often sparse (i.e., cover only a subset of the relevant businesses), skewed (i.e., some businesses are covered in great detail, others in little detail or not at all) and noisy (e.g., contain outliers such as direction requests that span multiple states).

To illustrate why this poses a challenge, consider the following scenario: assume that we want to use logs of driving direction requests obtained from a map vertical to assess the average distance that users drive to a certain business. This average is then used in ranking to determine how much to penalize businesses that are farther away. Now, for some businesses we may have only few direction requests ending at the business in our logs, in which case the average distance may be unrepresentative and/or overly skewed by a single outlier. Moreover, for some businesses we may not have any log entries at all, meaning that we have to fall back on some default value. In both cases, we may not adjust the ranking of the corresponding businesses well.

One approach to alleviate this issue is to model such statistical aggregates (i.e., the average driving distance in the example above) at multiple resolutions, which include progressively more “similar” objects or observations. While the coarser resolutions offer less coherent collections of objects, they yield more stable aggregates. When there is not enough information available about a specific object, one can then resort to the information aggregated at coarser levels, i.e., successively back off to collections of similar objects. Strategies of this nature have been used in different contexts including click prediction for advertisements, collection selection, as well as language models in information retrieval and speech recognition.

To give a concrete example, for the pizza scenario above we may want to expand the set of businesses based on which we compute the average driving distances to include businesses that (a) sell similar products/services and reside in the same area, (b) belong to the same chain (if applicable) and reside in different areas or (c) belong to the same type of business, regardless of location. All of the resulting averages can be used as separate features in the ranking process, with the ranker learning how to tradeoff between them.

The local search system provides an architecture to incorporate external data sources into the feature generation process for local search ranking. Examples of such data sources include logs of accesses to business web sites, customer ratings, GPS traces, and logs of driving direction requests. Each of these logs is modeled as a set O of objects O={O₁, . . . , Oₖ}. The features that we consider in this paper are defined through an aggregation function that is applied to a subset of the objects from an external data source O. Examples of such features are the average driving distances to a specific business (or a group of them), the median rating for a (set of) restaurant(s) or the count of accesses to a business web site. We refer to such features as aggregate features in the following. Note that some of these features (e.g., the median rating) can be computed up-front and associated with the entity returned by the local search engine, whereas others depend on the input query itself and have to be computed at query-processing time, which in turn means that our architecture has to have low latency.

Initially, a query and location are sent as an input to the local search engine; this request can come from a mobile device, from a query explicitly issued against a local search vertical, or a query posted against the web search engine for which local results shall be surfaced together with the regular results. In the latter two cases, the relevant (user) location can be inferred using IP-to-location lookup tables or from the query itself (e.g., if it contains a city name). As a result, a local search produces a ranked list of entities from a local search business database; for ease of notation, we will refer to these entities as businesses in the following, as these are the most common form of local search results. However, note that local search also may return sights, “points-of-interest”, landmarks, and other types of entities.

Ranking in local search usually proceeds as a two-step approach: an initial “rough” filtering step eliminates obviously irrelevant or too distant businesses, thus producing a filter set of businesses from the local search business database, which are then ranked in a subsequent second step using a learned ranking model. Our backoff methods operate in an intermediate step, enriching businesses in the filter set with additional features aggregated from a suitable subset of objects in the external data source O.

Given the current query Q, user location L, and a specific business B from the filter set, our methods thus select a subset of objects from the external data source O, the so-called backoff set, from which aggregate features are generated. In doing so, they are steered by a set of distance functions d₁, . . . dₘ each of which captures a different notion of distance between the triple (Q,L,B) (further referred to as source object) and an object O from the external data. Examples of distance functions, that we consider later on, include geographic business distance (e.g., measured in kilometers) and categorical business distance that reflects how similar two businesses are in terms of their business purpose.

There are many external data sources that the system can leverage using the architecture described herein. The first type of external data that we use for local search are logs of driving-direction requests, which could stem from map search verticals (such as maps.google.com/ or www.bing.com/maps/), web sites such as MapQuest or any number of GPS-enabled devices serving up directions. In particular, we focus on direction requests ending at a business that is present in our local search data.

Independent of whether the logs of direction requests record the actual addresses or latitude/longitude information, it is often not possible to tie an individual direction request to an individual business with certainty: in many cases (e.g., for a shopping mall) a single address or location is associated with multiple businesses and some businesses associate multiple addresses with a single store/location. Moreover, we found that in many cases users do not use their current location (or the location they start their trip from) as the staring location of the direction request, but rather only a city name (typically of a small town) or a freeway entrance. As a consequence, our techniques need to be able to deal with the underlying uncertainty; we use (additional) features associated with each business that encode how many other businesses are associated with the same physical location.

One concern with location information is location privacy; fortunately, our approach does not require any fine-grained data on the origin of a driving request and—because all features we describe are aggregates—they are somewhat resilient to the types of obfuscation in this context. In fact, any features whose value is strongly dependent on the behavior of a single user is by default undesirable for our purposes, as we want to capture common behavior of large groups of users.

The value of the direction request data stems from the fact that it allows us to much better quantify the impact of distance between a user and a local search result than mere geographic distance would. For one, the route length and estimated duration reflect the amount of “effort” involved to get to a certain business much better than the geographic distance, since they take into account the existing infrastructure. Moreover, in aggregate, the direction requests can tell us something about which routes are more likely to be traveled than others even when the associated length/duration is identical (something that can be due to a number of factors not directly related to the destination business, such as parking, nearby entertainment, etc.). We will illustrate this in detail in the following.

Direction request data can also be used to assess popularity, as a direction request is typically a much stronger indicator of the intent to visit a location than an access to the corresponding web site would be. However, they do not convey reliable data on the likelihood of repeated visits as users are not very likely to request the same directions more than once.

A hypothesis mentioned earlier was that users' “sensitivity” regarding distance is a function of the type of business considered. In order to test this, it is possible to use a multi-level tree of business categories (containing paths such as /Dining/Restaurants/That Cuisine); every business in the local search data was assigned to one or more nodes in this tree. This allows computing the average route length for driving requests in every category.

There are considerable differences between the average distances traveled to different types of businesses. Businesses associated with travel have the highest average, which is not at all surprising (the requests in this category are dominated by direction requests to hotels). While some of these numbers mainly reflect the density of businesses in categories where competition is not an issue (e.g., public institutions in the Government & Community category), larger averages in many cases also indicate a smaller “sensitivity” towards increased distances (e.g., entries in the fine-dining category). Consequently, we model both the distribution of driving distances for individual businesses as well as the “density” of alternatives around them in our features.

Some variation in the distance distribution of driving directions cannot be explained by the different business categories of the destinations themselves. For example, data showed that it is common for users from Redmond/Bellevue in Washington to drive to Seattle for dinner, but the converse does not hold. Hence, there appears to be a difference in the “distance sensitivity” for each group of users even though technically, the route lengths and durations are the same. While some of these effects can be explained by the greater density and (possibly quality) of restaurants in Seattle, a lot of the attraction of a large city lies in the additional businesses or entertainment offered.

Consequently, we either need to be able to incorporate distance models that are non-symmetric or be able to model the absolute location of a business (and its attractiveness) as part of our feature set. In the features we propose in this paper, we will opt for the second approach, explicitly modeling the popularity of areas (relative to a user's current location) as well as (the distance to) other attractions from the destination.

The second type of external data that we use is logs of Search Trails. These are logs of browsing activity collected with permission from a large number of users; each entry includes (among other things) an anonymous user identifier, a timestamp and the URL of the visited web page (where we track only a subset of pages for privacy reasons), as well as information on the IP address in use. This information enables us to reconstruct a temporally ordered sequence of page views.

Using these logs, we can now attempt to (partially) characterize the popularity of a specific business via the number of accesses we see to the web site associated with the business, by counting the number of distinct users, or the number of total accesses or even tracking popularity over time.

The main issue with tracking accesses here is how we define what precisely we count as an access to the web site stored with the business. For example, if the site of a business according to our local search data is www.joeyspizza.com/home/, do we also count accesses to www.joeyspizza.com/ or www.joeyspizza.com/home/staff/? For simplicity, here we consider an access a match if the string formed by the union of domain and path of a browsed URL is a super-string of the domain+path stored in our local search data (we ignore the port and query part of the URL).

Similar to the issues we discussed earlier encountered with associating businesses with individual locations, we also face the issue that in our local search data, some web site URLs are associated with multiple businesses (typically, multiple instances of the same chain). To address this, we keep track of the total number of accesses as well as the number of businesses associated with a site and encode this information as a feature.

We use the trail logs to derive features quantifying the popularity of businesses by tracking how often the corresponding sites are accessed over time. Here, the main advantage over search logs (local or otherwise) lies in the fact that trail logs allow us to account for accesses that originate from other sites (such as e.g., Yelp or Citysearch), which make up a very significant fraction of access for some types of businesses, especially smaller ones. Moreover, using the IP information contained in the logs, we can (using appropriate lookup tables) determine the zip code the access originated from with high accuracy, thereby allowing us to break down the relative popularity of a business by zip codes.

The final external data source that we use is logs of mobile search queries submitted to m.bing.com together with the resulting clicks from mobile users. The information recorded includes the GPS location from which the query was submitted, the query string submitted by the user, an identifier of the business(es) that was/were clicked in response to the query, and a timestamp. The system may include privacy settings that request permission for the user before using GPS or other user sensitive information.

We use these logs to derive features relevant to both popularity (by counting the number of accesses to a given (type of) business or area) as well as to capture the distance sensitivity (by grouping these accesses by the location of the mobile device the query originated from). For this purpose, the mobile search logs differ from the other sources discussed previously in two important ways: first, they give a better representation of the “origin” of a trip to a business than non-mobile logs—in part due to the factors discussed above for direction requests (where the origin of the request is often not clear) and in part because these requests are more likely to be issued directly before taking action in response a local search result. Second, mobile search logs contain significantly more accurate location information (e.g., via GPS, cell tower and/or Wi-Fi triangulation) compared to the reverse IP lookup-based approach used in the context of desktop-devices.

Having described our overall approach and the practical challenges associated with the external data sources that we want to leverage, we now introduce our general framework for distance-based backoff. We begin with an abstract definition of backoff from which we incrementally develop two concrete distance-based backoff methods. As we already noted above, one idea is to generate additional aggregate features for a concrete business in our filter set based on a subset of objects from the external data source. Selecting the subset of objects to consider is the task accomplished by a backoff method. Given a source object S=(Q,L,B) including the user's query Q, current location L, and the business B from our filter set, as well as an external data source O, a backoff method thus determines a backoff set B(S)⊂O of objects from the external data source.

Consider an example user from Redmond (i.e., L=(47.64, −122.14), when expressed as a pair of latitude and longitude) looking for a pizza restaurant (i.e., Q=[pizza]) and a specific business (e.g., B=[Joey's Pizza] as a fictitious pizza restaurant located in Bellevue). Our external data source in the example is a log of direction requests where each individual entry, for simplicity, includes a business, as the identified target of the direction request, and the corresponding route length.

Apart from that, we assume a set of distance function d₁, . . . , dₘ that capture different notions of distance between the source object S=(Q,L,B) and objects from the external data source. Example distance functions of interest in our running example could be: geographic business distance d_{geo} (in kilometers) between the locations associated with businesses B and O, or categorical business distance capturing how similar the two businesses are in terms of their business purpose. Letting Cat(S) and Cat(O) denote the sets of business categories (e.g., /Dining/Italian/Pizza) that the businesses are associated with, a sensible definition based on the Jaccard coefficient would be:

$${d}_{cat} ( S , O ) = 1.0 - \frac{\vert Cat ( S ) ⋂ Cat ( O ) \vert}{\vert Cat ( S ) ⋃ Cat ( O ) \vert}$$

One conceivable method is to include only objects in the backoff set for which all m distance functions report zero distance. In our running example, this only includes direction requests that have Joey's Pizza as a target location (assuming that there is no second pizza restaurant at exactly the same geographic location). Due to the sparseness of external data sources, though, this method would produce empty backoff sets for many businesses.

To alleviate this problem, we have to relax the constraints that we put on our distance functions. For our running example, we could thus include other pizza restaurants in the vicinity by relaxing the geographic distance to d_{geo}(S,O)≦2.5, include other very similar businesses (e.g., other restaurants) at the same location by relaxing d_{cat}≦0.1, or relax both constraints thus including all restaurants in the vicinity. Which choice is best, though, is not clear upfront and may depend on the business itself (e.g., whether Joey's Pizza is located in a shopping mall or at a lonely out-of-town location). Furthermore, it is not easy to pick suitable combinations of threshold values for the distance functions involved, as the notions of distance introduced by each function are inherently different.

We address the issue of “incompatible” distance functions by re-normalizing them in a generic manner so that the normalized distance conveys the fraction of objects that have a smaller distance than O from the source object. One useful property of the described normalization scheme is that it can be applied on the fly (i.e., in a non-blocking manner), if objects can be efficiently retrieved in ascending order of their original distance, which is often possible. For instance, for the geographic distance one can do so using appropriate spatial indexing and an algorithm for incremental nearest neighbor search.

Building on our distance normalization, we introduce an aggregated distance that captures the overall distance of object O. If needed, this definition can be extended by weights (e.g., to capture more elaborate trade-offs between distance functions) without reducing the applicability of the methods described in the following.

Our first method, coined near-neighbor backoff (NN), includes all objects in the backoff set that have an aggregated distance below a threshold. FIG. 4 illustrates near-neighbor backoff when applied to our running example. The determined backoff set contains all objects in the shaded triangle, i.e., only objects that are sufficiently close to the source object but none that is both geographically distant and pursue a very business different purpose (e.g., a Volvo dealer in Tacoma).

By its definition, near-neighbor backoff requires identifying all objects that have an aggregated distance below the specified threshold. If objects can be retrieved in ascending order of their distance, this can be done efficiently in practice. Other optimizations, such as those proposed for efficient text retrieval or top-k aggregation in databases, are also applicable in this case. In the worst case, though, one has retrieve distances for all objects and distance functions—since, in fact, all objects could be near neighbors.

Near-neighbor backoff, as explained above, ensures that all objects in the backoff set are individually close to the source object. Their distances according to the different distance functions, though, can be rather different, as can be seen from FIG. 4 where we include Farmer Tom's in Bellevue (a fictitious supermarket) and Pizza Palace in Seattle, each of which is close to the source according to one but maximally distant according to the other distance function considered. As this demonstrates, near-neighbor backoff may produce a set of objects that, though individual objects are close to the source, is incoherent as a whole.

Pivot backoff, which we introduce next, addresses this issue and goes beyond near-neighbor backoff by not only ensuring that objects in the backoff set are individually close to the source object but also choosing a coherent set of objects. To this end, the method chooses the backoff set relative to a pivot object that has maximal distance, among the objects in the backoff set, for every distance function. The pivot thus serves as an extreme object and characterizes the determined backoff set—all objects in it are at most as distant as the pivot. Since we are interest in determining reliable aggregate features in the end, we select the pivot object that yields the largest backoff set.

The pivot object is chosen so that the backoff set has maximal size, while ensuring that the pivot itself (and, in turn, all other objects in the backoff set) have aggregated distance below a specified threshold.

FIG. 4 illustrates pivot backoff when applied to our running example. The method determines Burrito Heaven in Redmond as a pivot, thus producing a backoff set that contains the seven objects falling into the shaded rectangle. Furthermore, we know that the backoff set does not contain objects that are at greater geographic or categorical distance than our pivot.

From the foregoing, it will be appreciated that specific embodiments of the local search system have been described herein for purposes of illustration, but that various modifications may be made without deviating from the spirit and scope of the invention. Accordingly, the invention is not limited except as by the appended claims.

I/We claim:

1. A computer-implemented method for perform a search of local entities using supplemental location-specific information, the method comprising:
receiving a search query from a user searching for one or more local entities;
performing a general search that identifies a body of matching results;
pre-filtering the identified results to eliminate irrelevant search results;
acquiring one or more features of supplemental information related to location that provide one or more hints describing relevance of individual search results;
smoothing one or more features of the acquired supplemental information to handle data sparseness and anomalies;
ranking the search results based on the smoothed features of the acquired supplemental data; and
outputting the ranked results to the user,
wherein the preceding steps are performed by at least one processor.

2. The method of claim 1 wherein receiving the search query comprises receiving a query to identify entities that include businesses, landmarks, people, or other geographically locatable objects.

3. The method of claim 1 wherein receiving the search query comprises receiving the query with location information derived from a mobile device that captures the user's current location or a location provided in the query.

4. The method of claim 1 wherein the general search includes content items that matched the query based on keywords, and where the system ranks the content items to bring location-relevant results to the top of a list of results.

5. The method of claim 1 wherein pre-filtering identifies some results as clearly not relevant or beyond a threshold so that the system can reduce the size of the list of results for which the system performs supplemental information processing.

6. The method of claim 1 wherein acquiring supplemental information comprises acquiring a log of driving direction requests to a location of a local entity associated with each search result.

7. The method of claim 1 wherein acquiring supplemental information comprises acquiring a log of reviews or other rankings of an entity associated with each search result.

8. The method of claim 1 wherein smoothing comprises applying a backoff function to loosen particular feature values where sufficient matching data is not available and subsequent aggregation over the matching data.

9. The method of claim 1 wherein smoothing comprises applying a backoff function to reduce the impact of infrequently occurring outlying data values.

10. The method of claim 1 wherein ranking the search results comprises applying the smoothing to increase the rank of local entities that other users have rated highly.

11. The method of claim 1 wherein ranking the search results comprises applying the smoothing to increase the rank of local entities for which other users been willing to drive a similar distance as the user's distance to visit based on driving direction requests.

12. The method of claim 1 wherein outputting the ranked results comprises displaying the results on a display of a mobile device.

13. A computer system for performing local search using feature backoff, the system comprising:
a processor and memory configured to execute software instructions embodied within the following components;
a query receiving component that receives a query from a user that requests a search for local businesses;
a search component that performs a search based on the query using a pre-built search index that classifies a set of content;
a data acquisition component that acquires supplemental information for ranking multiple identified search results from one or more external data sources;
a data backoff component that applies one or more backoff criteria to acquired supplemental information to manage errors or sparseness in the acquired data; and
a result ranking component that ranks search results according to the applied backoff criteria and acquired supplemental information.

14. The system of claim 13 wherein the external data sources include at least one of a click logs, driving direction logs, time information, location information, distance information, weather information, and user demographic information.

15. The system of claim 13 wherein the data acquisition component operates on a periodic basis independent of arrival of search requests to gather and process supplemental information before queries arrive to reduce impact on query processing performance.

16. The system of claim 13 wherein the data backoff component leverages neighboring information for sparse data to make informed guesses and provide relevance ranking for results related to the user's location.

17. The system of claim 13 wherein the data backoff component applies backoff in multiple dimensions to smooth unrelated or related types of data gathered from difference sources.

18. The system of claim 13 wherein the data backoff component applies backoff using a pivot model that ensures coherence between results along multiple dimensions.

19. The system of claim 13 further comprising a backoff cache component that caches processed results from the data acquisition component and the data backoff component to save time during subsequent search queries.

20. A computer-readable storage medium comprising instructions for controlling a computer system to smooth potentially unreliable supplemental information with backoff, wherein the instructions, upon execution, cause a processor to perform actions comprising:
receiving one or more dimensions of supplemental information for ranking results of a local search query designed to identify one or more local entities related to a search query;
selecting at least one received dimension;
retrieving dimension data related to the selected dimension;
determining a reliability measure of the retrieved dimension data;
applying backoff to identify related dimension data that fills any gaps in data for the selected dimension;
aggregating data for each dimension to create a score for each search result; and
applying the aggregated dimension data to rank search results.
